(19) United States
(12) Patent Application Publication
(10) Pub. No.: US 2017/0356342 A1
(43) Pub. Date: Dec. 14, 2017

(54) CIRCUIT-LEVEL HEATING FOR WIDE WOBBE FUELS IN DLN GAS TURBINE COMBUSTION

(71) Applicant: General Electric Company, Schenectady, NY (US)

(72) Inventors: David Leach, Simpsonville, SC (US); Daniel R. Tegel, Greenville, SC (US); Alston Ilford Scipio, Mableton, GA (US); Praveen Kumar Uppaluri, Mauldin, SC (US); Vishwanath R. Ardha, Greer, SC (US); Sanji Ekanayake, Mableton, GA (US)

(21) Appl. No.: 15/182,003

(22) Filed: Jun. 14, 2016

(51) Int. Cl. F02C 7/224; F02C 7/22; F02C 3/04; F23R 3/28; F02C 9/26; F01K 17/02; F23R 3/12

(52) U.S. Cl. CPC F02C 7/224; F01K 17/025; F02C 7/222; F23R 3/12; F23R 3/286; F02C 9/26; F02C 3/04; F05D 2220/32; F05D 2260/20; F05D 2240/35

(57) ABSTRACT

A gas turbine fuel heating system is disclosed having at least one coalescing filter configured to accept a main fuel supply and a plurality of fuel circuit heaters. Each fuel circuit heater can be configured to accept an independent fuel circuit portion of the main fuel supply leaving the at least one coalescing filter and also configured to accept a heating medium circuit portion of a heating medium. The system can have a plurality of scrubbers, a plurality of fuel circuit manifolds, and a plurality of fuel premix tubes. A controller circuit determines the MWI for each independent fuel circuit portion and adjusts the heating medium circuit portion passed to the corresponding fuel circuit heater to maintain at least one parameter selected from the group consisting of a baseline independent fuel circuit portion MWI setpoint and a predetermined independent fuel circuit portion nozzle gas injector pressure ratio.

### FIELD OF THE DISCLOSURE

This disclosure relates to the fuel systems for gas turbines, and more specifically to a system and method for independently heating a plurality of fuel circuits supplying wide Wobbe Number fuels to a dry low NOₓ (DLN) combustion system in a gas turbine.

### BACKGROUND OF THE DISCLOSURE

Industrial turbines are often gas-fired and are commonly used to drive electrical generators in power plants. Such gas turbines are designed to burn a specific range of fuels, wherein the rate of fuel consumed may depend on the fuel's chemical composition. Nevertheless, the precise chemical composition of the fuel being burned is not immediately known due to pipeline variability and fuel-gas processing (e.g. regasification of liquid natural gas (LNG)). Burning fuel of unknown composition can lead to degraded gas turbine system performance. Many problems associated with burning an unknown fuel can be abated by robust control over the gas turbine if fuel properties are measured prior to combustion, particularly if these properties are varying quickly. In addition to fuel constituent concentrations, fuel heating value and specific gravity are key fuel properties for gas turbine operation. Both are represented by the fuel Wobbe Number (WN) and Modified Wobbe Index (MWI).

Historically, the Modified Wobbe Index (MWI) for pipeline natural gas composition has varied only slightly. Fuel nozzle gas injection areas are sized for a limited range of fuel MWI, typically less than about plus or minus five percent of the design value, and for gas turbine with DLN (Dry Low NOx) combustion systems with multiple fuel injection points, the gas turbine combustion system is set up with fuel distribution schedules such that the fuel splits among the various injection points vary with machine operating conditions. For some DLN combustion systems, if fuel properties change by a value of more than about plus or minus two percent in MWI, it is necessary to make fuel schedule adjustments while monitoring both emissions and combustion acoustic pressure oscillation levels. Such fuel schedule adjustments is called “tuning” and the process requires technicians to set up special instrumentation and may take a day or longer to accomplish. Furthermore, when the fuel supplied to a specific gas turbine installation is from more than one source which are of different compositions and resulting MWI, it is necessary to “retune” the fuel split schedules with repeated tuning for each fuel supply switch. Furthermore, any blend of the two or more fuels is the equivalent of another fuel composition and as a result a variable blend of the fuels cannot be tolerated.

Many gas turbine combustors achieve low NOx emissions levels by employing lean premixed combustion wherein the fuel and an excess of air that is required to burn all the fuel are mixed prior to combustion to control and limit thermal NOx production. This class of combustors, often referred to as Dry Low NOx (DLN) combustors, requires more careful management of combustion conditions to achieve stable operation, and acceptable NOx and CO emissions while remaining free of pressure oscillations called dynamics which are usually related to the combination of acoustics and unsteady energy release during the combustion process. Such systems often require multiple independently controlled fuel injection points supplied by multiple fuel circuits or fuel nozzles in each of one or more parallel combustors to allow gas turbine operation from start-up through full load. Furthermore, such DLN combustion systems often function well over a relatively narrow range of fuel temperatures and fuel injector pressure ratio, said pressure ratio being a function of fuel flow rate, fuel passage flow area, and gas turbine cycle pressures before and after the fuel nozzles. Such pressure ratio limits are managed by selection of the correct fuel nozzle passage areas and regulation of the fuel flows and temperatures to the several fuel nozzle groups. The correct fuel nozzle passage areas are based on the actual fuel properties which are nominally assumed to be constant.

To compensate for the wide range of fuels and improve gas turbine engine efficiency, an available source of heating medium, such as low energy steam or water, can be used to preheat the fuel gas entering the gas turbine combustor. For gas turbines employing heated gas, load up time may depend on the time required to generate the heating medium, such as hot water, in the initially cool heat recovery steam generator to heat the fuel gas to a minimum required level. Until the fuel gas reaches the required temperature and consequently the required MWI, some combustor designs are unable to operate in the low NOx combustion mode. Increasing the temperature of the gas fuel, with heat taken from the steam cycle, before it is burned in the gas turbine enhances the overall thermal performance of the power plant. Heating is used to increase the fuel gas temperature to a range of 365 F/185 C to up to more than 392 F/200 C. This heating generally improves gas turbine efficiency by reducing the amount of fuel required to achieve the desired firing temperature. Proper design, configuration, control and operation of the gas fuel system are critical in ensuring reliable and stable operation of the gas turbine. In a combined cycle configuration, it is a standard design attribute for each gas turbine/heat recovery steam generator (HRSG) unit to be equipped with a gas fuel performance heater.

The performance heater typically consists of two reverse-flow heat exchanger shells in series. The motive fuel/heating medium for the gas heating is hot feed water which is taken from the outlet of the Intermediate Pressure (IP) or Low pressure (LP) economizer of the HRSG. The gas fuel heater discharges its used water from the heating process into the condenser. This gas heating system is based on the “one large heater” concept configured and operated to maximize the performance benefit available from fuel heating. Achieving this objective requires that the water leaving the fuel heater en-route to the condenser be as cold as possible and the fuel gas to the gas turbine as hot as possible. In order to meet both objectives, the performance fuel heater is controlled to maintain the target fuel temperature without exceeding a pinch point between water inlet and fuel gas outlet temperature. Utilizing this control philosophy, ensures that the returning water into the condenser, is not heated to the point where its contribution to the heater would have been inefficient.

Based on field experiences, the “one large heater” strategy presents several challenges that impact plant availability, performance and operability. Complications include heat exchanger performance leaks; equipment layout constraints to locate and install one large heater; thermal losses in equipment and long piping runs that impact plant efficiency; limited capability to meet the MWI requirements of the gas due to thermal losses; gas source changes and MWI requirements demanding gas temperatures outside the range of the single heater; single heater imposes tuning limits for individual combustors; response time for fuel temperature changes are very slow; gas temperature excursions during incidents of full load rejection; poor temperature control at part load and turndown operation; and one large heater being the single point failure for the fuel system.

### BRIEF DESCRIPTION OF THE DISCLOSURE

Aspects and advantages of the disclosure will be set forth in part in the following description, or may be obvious from the description, or may be learned through practice of the disclosure.

A gas turbine fuel heating system is disclosed having at least one coalescing filter configured to accept a main fuel supply and a plurality of fuel circuit heaters. Each fuel circuit heater can be configured to accept an independent fuel circuit portion of the main fuel supply leaving the at least one coalescing filter and also configured to accept a heating medium circuit portion of a heating medium. The system can have a plurality of scrubbers, each scrubber configured to accept the independent fuel circuit portion corresponding with a specific fuel circuit heater, and can have a plurality of fuel circuit manifolds, each manifold configured to accept the independent fuel circuit portion corresponding with a specific scrubber. The system can have a plurality of fuel premix tubes, each premix tube configured to accept the independent fuel circuit portion corresponding with a specific manifold, and can have a controller circuit having at least one MWI sensor configured to determine the MWI for each independent fuel circuit portion and adjust the heating medium circuit portion passed to the corresponding fuel circuit heater thereby maintaining at least one parameter selected from the group consisting of a baseline independent fuel circuit portion MWI setpoint and a predetermined independent fuel circuit portion nozzle gas injector pressure ratio.

The gas turbine fuel heating system can be embodied in a gas turbine system having an air compressor, one or more fuel combustors having air/fuel premixers, a gas turbine to expand combusted fuel into fuel exhaust, and a heat recovery steam generator having a steam generator with a heat exchanger to generate steam from the gas turbine fuel exhaust. The steam turbine can be configured to generate a heating medium for the fuel heating system.

A method for heating gas turbine fuel is disclosed having the steps of supplying a heating medium to a plurality of fuel circuit heaters, supplying fuel to the plurality of fuel circuit heaters, each fuel circuit heater being configured to accept an independent fuel circuit portion of a main fuel supply and exchange heat with a heating medium circuit portion of the heating medium, measuring the MWI of each independent fuel circuit portion using MWI sensors configured as part of a controller circuit, and adjusting the heating medium flow through each corresponding heating medium circuit portion to maintain at least one parameter selected from the group consisting of a baseline independent fuel circuit portion MWI setpoint and a predetermined independent fuel circuit portion nozzle gas injector pressure ratio.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 is a schematic diagram of a combined-cycle power plant having a gas turbine and heat recovery steam generator (HRSG) for circuit-level fuel heating as may incorporate at least one embodiment of the present disclosure;

FIG. 2 is a schematic of the fuel side of a circuit-level fuel heating system as may incorporate at least one embodiment of the present disclosure;

FIG. 3 is a forward end view of a combustion liner cap assembly;

FIG. 4 is a graph of the gas turbine operating modes when using MWI fuel heating control;

Repeat use of reference characters in the present specification and drawings is intended to represent the same or analogous features or elements of the present disclosure.

### DETAILED DESCRIPTION OF THE DISCLOSURE

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location, or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component and/or substantially perpendicular to an axial centerline of the turbomachine, and the term “axially” refers to the relative direction that is substantially parallel and/or coaxially aligned to an axial centerline of a particular component and/or to an axial centerline of the turbomachine, and the term “circumferentially” refers to the relative direction that is substantially parallel to the circumference of a particular component and/or substantially parallel to the turbomachine annular casing element.

Although an industrial, marine, or land based gas turbine is shown and described herein, the present disclosure as shown and described herein is not limited to a land based and/or industrial, and/or marine gas turbine unless otherwise specified in the claims. For example, the disclosure as described herein may be used in any type of turbine including but not limited to an aero-derivative turbine or marine gas turbine.

Two fuel parameters used herein that are defined for the incoming gas are the Wobbe Number (WN) and the Modified Wobbe Index (MWI) of the gas supplied to the turbine. The WN is defined as:

$$WN = \frac{HHV}{\sqrt{SG}}$$

where HHV is the higher heating value of the gas fuel and SG is the specific gravity of the gas fuel mixture relative to air. The WN is used as an interchangeability index to permit gas fuels of various heating values to be utilized in the same combustion system without changing hardware. Temperature is not included in this equation for WN because gas is typically delivered at approximately ground temperature with little variation throughout the year. The MWI is defined as:

$$MWI = \frac{LHV}{\sqrt{( ( SG \times ( 460 + Tg ) )}}$$

where LHV is the lower heating value of the gas fuel and Tg is the gas fuel temperature in degrees F. MWI more accurately measures the energy delivered through a fuel nozzle at a given injector pressure ratio than WN. This distinction between MWI and WN becomes very important when gas fuel is heated before delivery to the gas turbine.

Any change in the fuel compositions may result in unacceptable levels of combustion dynamics as it has been determined that combustion dynamics are a function of MWI. Decreasing the MWI also results in increasing the pressure drop across the fuel injection holes resulting in changes to the fuel system impedance characteristics. One method to control the dynamics is to determine the baseline MWI which has favorable combustion instabilities. Then, the incoming fuel composition MWI is compared with the baseline MWI and adjusted to at least one of the baseline MWI or a predetermined independent fuel circuit portion gas injector pressure ratio, either by increasing or decreasing the fuel temperatures using independent fuel heaters mounted on the respective fuel circuits, and the amount of individual premix circuit fuel flow. With this method of fuel utilization, fuel nozzle impedance characteristics can now be varied or modified not only by changing the fuel splits but also by changing/adjusting the fuel temperature in the individual premix circuits which can produce a more favorable acoustic response from individual flames. This provides capability to independently adjust the fuel temperature and flow in each of the fuel circuits, and effectively altering the fuel flow and injector pressure ratio conditions in fuel circuits which produces a more favorable acoustic response from individual premixed flames. The resulting variation in the individual circuit's impedance and heat release provides the capability to effectively dampen unfavorable combustion dynamics. Independent fuel circuit portion heating provides ability to maintain baseline MWI in each circuit, and provides ability to adjust both fuel flow and gas fuel pressure ratio for each fuel circuit, thus providing an extra tuning knob for dynamics. Previously, fuel flow could be adjusted, but pressure ratio was done for all fuel circuits simultaneously by adjusting fuel temperature for all circuits in one large performance heater.

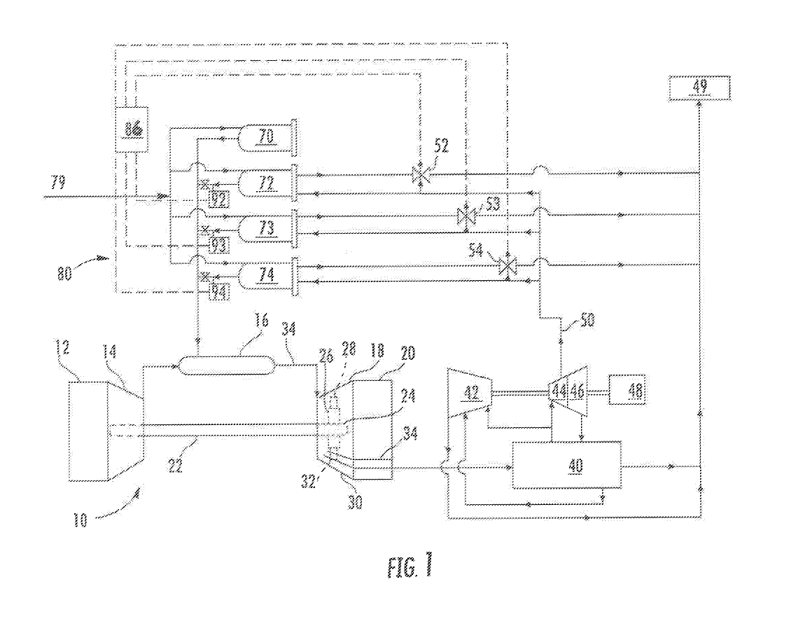

Referring now to the drawings, FIG. 1 illustrates a schematic diagram of one embodiment of a combined-cycle power plant having a gas turbine 10 with circuit-level fuel heating provided by a heat recovery steam generator 40. The gas turbine 10 generally includes an inlet section 12, a compressor section 14 disposed downstream of the inlet section 12, a plurality of combustors (not shown) within a combustor section 16 disposed downstream of the compressor section 14, a turbine section 18 disposed downstream of the combustor section 16 and an exhaust section 20 disposed downstream of the turbine section 18. The combustor section 16 fuel is supplied from a circuit-level heating system 80. Additionally, the gas turbine 10 may include one or more shafts 22 coupled between the compressor section 14 and the turbine section 18.

The turbine section 18 may generally include a rotor shaft 24 having a plurality of rotor disks 26 (one of which is shown) and a plurality of rotor blades 28 extending radially outwardly from and being interconnected to the rotor disk 26. Each rotor disk 26 in turn, may be coupled to a portion of the rotor shaft 24 that extends through the turbine section 18. The turbine section 18 further includes an outer casing 30 that circumferentially surrounds the rotor shaft 24 and the rotor blades 28, thereby at least partially defining a hot gas path 32 through the turbine section 18.

During operation, a working fluid such as air flows through the inlet section 12 and into the compressor section 14 where the air is progressively compressed, thus providing pressurized air to the combustors of the combustion section 16. The pressurized air is mixed with fuel and burned within each combustor to produce combustion gases 34. The combustion gases 34 flow through the hot gas path 32 from the combustor section 16 into the turbine section 18, where the energy (kinetic and/or thermal) is transferred from the combustion gases 34 to the rotor blades 28, thus causing the rotor shaft 24 to rotate. The mechanical rotational energy may then be used to power the compressor section 14 and/or to generate electricity. The combustion gases 34 exiting the turbine section 18 may then be exhausted from the gas turbine 10 via the exhaust section 20, into a heat recovery steam generator (HRSG) 40. Steam from the HRSG 40 is expanded through a high pressure turbine(HP) section 42, then an intermediate pressure turbine (IP) section 44, and finally through a low pressure turbine (LP) section 46 before exhausting to a condenser 49. The turbine shaft rotates a power generator 48.

The circuit-level fuel gas heating system 80 is typically heated by hot water 50 supplied from the HRSG IP economizer. The hot water 50 passes through circuit-level hot water control valves 51-54 in route to corresponding circuit-level fuel heaters 72-74. Fuel conditions leaving each fuel heater 72-74 are measured by MWI sensors 92-94 that provide input to a controller circuit 86 that conditions a control signal for each hot water control valve 51-54 to maintain a baseline circuit MWI setpoint as determined by the gas turbine controller circuit 86. The MWI sensors 92-94 can be an optical diagnostic device of at least one type selected from the group consisting of tunable diode laser absorption spectroscope, emissions spectroscope, and fiber pyrometer as taught in commonly-owned U.S. Pat. No. 9,249,737, titled “METHODS AND APPARATUS FOR RAPID SENSING OF FUEL WOBBE INDEX” issued Feb. 2, 2016.

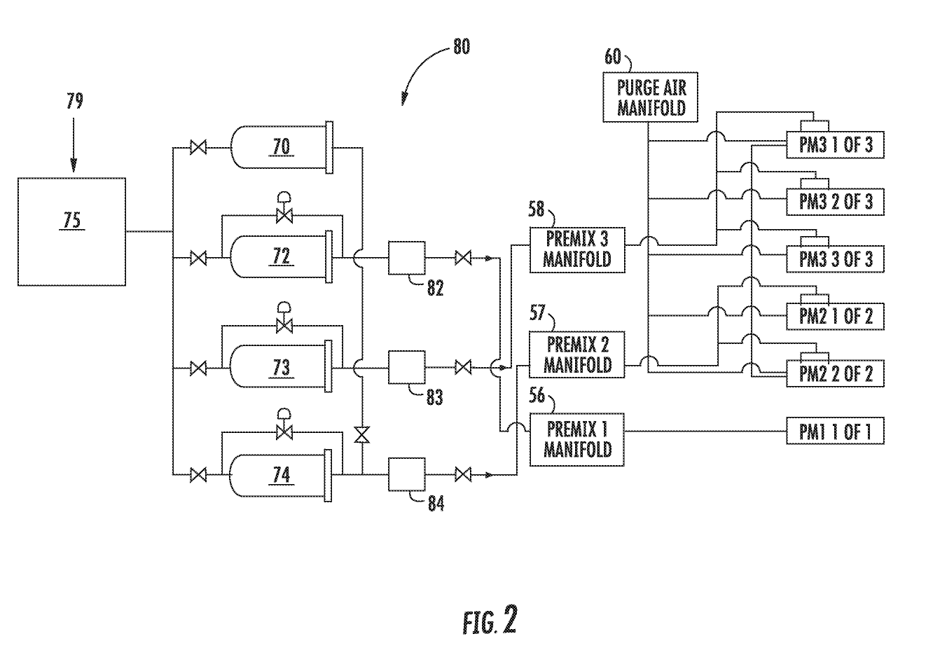

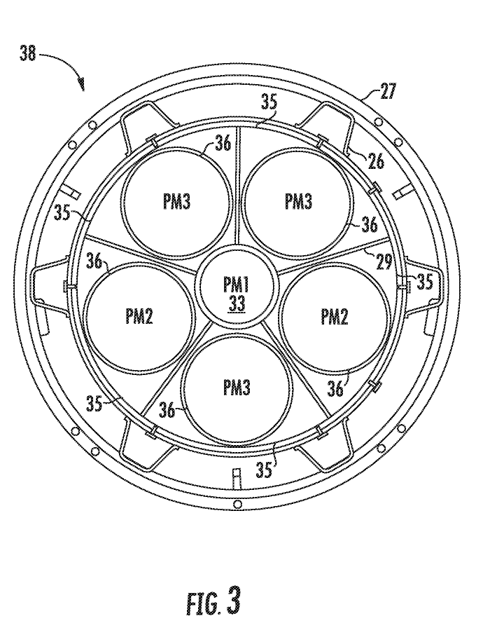

Referring now to FIG. 2 schematic showing the fuel side of a circuit-level fuel heating system 80, as the incoming main gas fuel supply 79 enters the plant facility, it first passes through at least one coalescing filter 75. These coalescing filter(s) 75 are required to remove both liquids and particulate from the customer's gas supply. Downstream of the coalescing filter(s) 75, the gas fuel supply enters the electric startup heater 70. This startup heater 70 is required when the gas supply 79 does not meet the minimum superheat requirement. The electric heater 70 is turned off and then bypassed at the point when the circuit-level heaters 72-74 are capable of maintaining gas temperatures above the minimum superheat requirement. When the electric heater 70 is off, fuel enters the circuit-level heaters 72-74. The circuit-level heaters 72-74 can incorporate a shell & tube heater arrangement with the gas on the shell side and the hot water on the tube side. The gas fuel exiting the circuit-level heaters 72-74 enters the gas fuel scrubbers 82-84. This “dry” scrubber performs two functions in that it provides the final level of particulate filtration upstream of the gas turbine, and removes gas entrained water droplets present as the result of a possible minor tube leak (i.e., pinhole). Gas fuel exiting the fuel scrubbers 82-84 enters gas fuel supplying manifolds 56, 57, and 58 to supply fuel that is ultimately introduced to a combustor. As seen in FIGS. 2 and 3, premix 1 (PM1) manifold 56 supplies fuel to center fuel nozzle 33. Premix 2 (PM2) manifold 57 supplies fuel for premixing to two of the five outer fuel nozzles 36 arranged relative to combustion liner cap assembly 25 as shown in FIG. 3. Premix 3 manifold 58 supplies fuel for premixing to three of five outer fuel nozzles 36 arranged relative to combustion liner cap assembly 25. Purge air for passages which do not receive a fuel supply in all modes of operation is supplied to the five outer fuel nozzles via purge air manifold 60.

In FIG. 3, combustion liner cap assembly 38 includes openings for outer fuel nozzles 36 and their premix tubes, and an opening for center fuel nozzle 33 and its premix tube, all openings disposed in forward support plate 29. In some configurations, forward support covers 35 are included and are mounted to forward support plate 29. Forward support covers 35 aid in securing each of the outer premix tubes on the forward end.

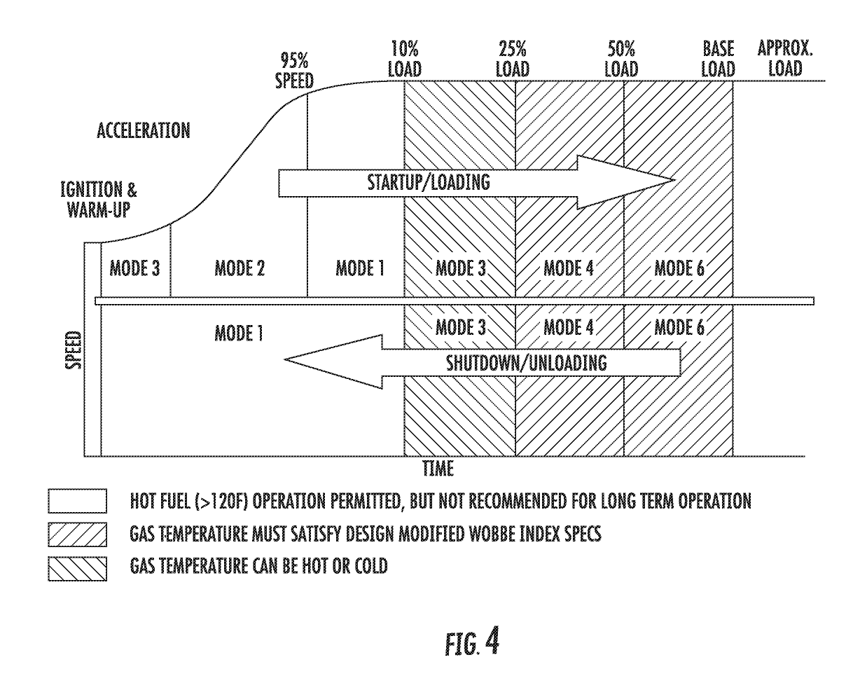

Referring to the mode graph of FIG. 4, exemplary configurations of each combustor can have a plurality of normal operating modes on gas fuel. These modes are configured to support different portions of the operational range of gas turbine 10. A combustor is ignited in mode3, and a gas turbine rotor accelerated to 95% speed in Mode 2. Mode2 has gas fuel supplied by the PM2 manifold 57 to the PM2 fuel nozzles. Mode3 has gas fuel supplied by PM1 manifold 56 to the PM1 fuel nozzle, and gas fuel supplied by the PM2 manifold 57 to the PM2 fuel nozzles. At approximately 95% turbine rotor speed condition, a transition to the Mode 1 premix mode occurs. This transition initiates fuel flow in premix 1 (PM1) fuel circuit or manifold 56, and terminates fuel flow to gas manifold 57 and the PM2 fuel nozzles, allowing the rotor to achieve a full speed condition (100% speed) with minimal or reduced load application to the turbine rotor. This operational sequence provides constant fueling of premix 1 fuel manifold 56 for all rotor speeds and loads greater than the 95% speed, no load condition. As a result, premix 1 fuel manifold 56 does not require purge air at any time during operation. During Mode 1, purge air is supplied to premix 2 fuel manifold 57 and premix 3 fuel manifold 58. At a preselected gas turbine reference firing temperature condition between 100% rotor speed up to a minimal load condition, a mode transition to premix mode 3 is initiated as premix 2 manifold 57 begins fueling the combustor while premix 3 manifold 58 continues to be air purged. In mode 3 premix mode, premix 1 manifold 56, and premix 2 manifold 57 are all fueled. The mode 3 premix mode is a very stable, non-low emissions mode that can use either hot or cold fuel.

At approximately 25% load or higher, a mode transition to mode 4 premix circuit-level heating mode is scheduled, where the PM1 gas manifold 56 continues to supply gas to the PM1 fuel nozzle, the PM3 gas manifold 58 supplies gas fuel to the PM3 fuel nozzle, and the PM2 gas manifold 57 gas fuel flow is terminated. In this circuit-level heating mode of the operation sequence, the controller circuit 86 uses the circuit modified Wobbe index measured by MWI sensors 92-94 to modulate the hot water control valves 51-54 to maintain a baseline MWI setpoint that is mode-specific. In mode 4 premix mode, combustion dynamics are improved by maintaining the baseline MWI which has less combustion instabilities. The incoming fuel composition MWI is compared with the baseline MWI and adjusted to the baseline MWI either by increasing or decreasing the fuel temperatures using independent fuel heaters 72-74 and premix circuits 56-58 mounted on the respective fuel circuits. In mode 4 premix mode, as the split of total fuel flow is modulated as a function of reference firing temperature to the premix fuel manifolds 56, and 58. Above approximately 50% load, mode 6 is scheduled where gas fuel is supplied from manifold 56, 57, 58 to fuel nozzles PM1, PM2 and PM3 respectively. Acceptable flame stability and low dynamic pressures are simultaneously realized as a result of the ability of the fuel system to control axisymmetric fuel staging within combustion burning zone, and independently heat fuel supplied to each fuel circuit to maintain a baseline MWI setpoint and/or a targeted fuel nozzle gas injection pressure ratio.

Hot fuel (>120° F.) is permitted in modes 1, 2 and 3 from ignition up to about 10% load, but hot fuel is not recommended in this operating range for long term operation. Between about 10% and 25% load, mode 3 can use either hot or cold fuel and the independent fuel circuit portion temperatures can be controlled in accordance with this disclosure. Above about 25% load, the gas temperature of each independent fuel circuit portion is adjusted to satisfy design MWI specifications and maintain at least one of a baseline independent fuel circuit portion MWI setpoint and a predetermined independent fuel circuit portion nozzle gas injector pressure ratio. Additionally, independent fuel circuit portion temperatures can be controlled for any operating mode during startup or shutdown.

This written description uses examples to disclose the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine fuel heating system, comprising;
at least one coalescing filter configured to accept a main fuel supply;
a plurality of fuel circuit heaters, each fuel circuit heater configured to accept an independent fuel circuit portion of the main fuel supply leaving the at least one coalescing filter and configured to accept a heating medium circuit portion of a heating medium;
a plurality of scrubbers, each scrubber configured to accept the independent fuel circuit portion corresponding with a specific fuel circuit heater;
a plurality of fuel circuit manifolds, each manifold configured to accept the independent fuel circuit portion corresponding with a specific scrubber;
a plurality of fuel premix tubes, each premix tube configured to accept the independent fuel circuit portion corresponding with a specific manifold; and
a controller circuit comprising at least one MWI sensor configured to determine the MWI for each independent fuel circuit portion and adjust the heating medium circuit portion passed to the corresponding fuel circuit heater thereby maintaining at least one parameter selected from the group consisting of a baseline independent fuel circuit portion MWI setpoint and a predetermined independent fuel circuit portion nozzle gas injector pressure ratio.

2. The fuel heating system of claim 1, further comprising an electric startup heater.

3. The fuel heating system of claim 1, wherein the plurality of fuel circuit heaters comprise shell and tube heat exchangers.

4. The fuel heating system of claim 1, wherein the controller circuit further comprises a plurality of operating modes supporting different portions of an operational range of the gas turbine.

5. The fuel heating system of claim 4, wherein the controller circuit maintains the at least one parameter in operating modes above about 25% load.

6. The fuel heating system of claim 1, wherein the MWI sensors comprise at least one optical diagnostic device selected from the group consisting of tunable diode laser absorption spectroscope, emissions spectroscope, and fiber pyrometer.

7. A gas turbine system, comprising:
an air compressor;
one or more fuel combustors comprising air/fuel mixers and a fuel heating system;
a gas turbine to expand combusted fuel into fuel exhaust; and
a heat recovery steam generator, comprising;
a steam generator comprising a heat exchanger to generate steam from the gas turbine fuel exhaust,
a steam turbine configured to generate a heating medium for the fuel heating system;
wherein the fuel heating system comprises;
at least one coalescing filter configured to accept a main fuel supply;
a plurality of fuel circuit heaters, each fuel circuit heater configured to accept an independent fuel circuit portion of the main fuel supply leaving the at least one coalescing filter and configured to accept a heating medium circuit portion of a heating medium;
a plurality of scrubbers, each scrubber configured to accept the independent fuel circuit portion corresponding with a specific fuel circuit heater;
a plurality of fuel circuit manifolds, each manifold configured to accept the independent fuel circuit portion corresponding with a specific scrubber;
a plurality of fuel premix tubes, each premix tube configured to accept the independent fuel circuit portion corresponding with a specific manifold; and
a controller circuit comprising at least one MWI sensor configured to determine the MWI for each independent fuel circuit portion and adjust the heating medium circuit portion passed to the corresponding fuel circuit heater thereby maintaining at least one parameter selected from the group consisting of a baseline independent fuel circuit portion MWI setpoint and a predetermined independent fuel circuit portion nozzle gas injector pressure ratio.

8. The gas turbine system of claim 7, further comprising an electric startup heater.

9. The gas turbine system of claim 7, wherein the plurality of fuel circuit heaters comprise shell and tube heat exchangers.

10. The gas turbine system of claim 7, wherein the controller circuit further comprises a plurality of operating modes supporting different portions of an operational range of the gas turbine.

11. The gas turbine system of claim 10, wherein the controller circuit maintains the at least one parameter in operating modes above about 25% load.

12. The gas turbine system of claim 7, wherein the at least one MWI sensor comprises at least one optical diagnostic device selected from the group consisting of tunable diode laser absorption spectroscope, emissions spectroscope, and fiber pyrometer.

13. A method for heating gas turbine fuel comprising the steps of:
supplying a heating medium to a plurality of fuel circuit heaters;
supplying fuel to the plurality of fuel circuit heaters, each fuel circuit heater configured to accept an independent fuel circuit portion of a main fuel supply and exchanging heat with a heating medium circuit portion of the heating medium; and
measuring the MWI of each independent fuel circuit portion using MWI sensors configured as part of a controller circuit; and
adjusting the heating medium flow through each corresponding heating medium circuit portion to maintain at least one parameter selected from the group consisting of a baseline independent fuel circuit portion MWI setpoint and a predetermined independent fuel circuit portion nozzle gas injector pressure ratio.

14. The method of claim 13, wherein said heating medium is generated by a heat recovery steam generator.

15. The method of claim 14, wherein the heating medium is generated by an intermediate pressure economizer of the heat recovery steam generator.

16. The method of claim 13, further comprising the initial step of heating the fuel during startup with an electric startup heater.

17. The method of claim 13, wherein the plurality of fuel circuit heaters comprise shell and tube heat exchangers.

18. The method of claim 13, wherein the controller circuit further comprises a plurality of operating modes supporting different portions of an operational range of the gas turbine.

19. The method of claim 18, wherein the controller circuit maintains the at least one parameter in operating modes above about 25% load.

20. The method of claim 13, wherein the MWI sensors comprise at least one optical diagnostic device selected from the group consisting of tunable diode laser absorption spectroscope, emissions spectroscope, and fiber pyrometer.
